(19) United States
(12) Patent Application Publication
(10) Pub. No.: US 2007/0117881 A1
(43) Pub. Date: May 24, 2007

(54) Non-asbestos friction member

(76) Inventors: Akira Watanabe, Tokyo (JP); Osamu Nakajima, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/598,060

(22) Filed: Nov. 13, 2006

(30) Foreign Application Priority Data
Nov. 14, 2005 (JP) P.2005-329275
Sep. 11, 2006 (JP) P.2006-245483

(51) Int. Cl. C08J 5/14

(52) U.S. Cl. 523/153; 523/155

(57) ABSTRACT

A friction material containing a thermosetting resin binder, reinforcing fibers, and a friction modifier are integrally formed with a pressure plate. The friction material has a first layer friction material on a side of a friction surface and a second layer friction material on a side of the pressure plate. A pre-mix containing an elastomer and a cross-linker is blended in the second layer friction material. The premix preferably contains fibers, and the premix preferably contains 10 to 97 vol % of an elastomer blended therewith.

This application claims foreign priority from Japanese Patent Application Nos. 2005-329275 (filed on Nov. 14, 2005) and 2006-245483 (filed on Sep. 11, 2006), the entire contents of which are hereby incorporated by reference.

### BACKGROUND OF THE INVENTION

1. Field of the Invention

The present invention relates to a non-asbestos friction member used for disc brakes used in various kinds of vehicles and industrial machines.

2. Related Art

Friction materials have been prepared by mixing and thermoforming various granular, powdery, and fibrous ingredients. However, along with the trend of using non-asbestos friction members for preventing public pollution, usable ingredients have become restricted and powdery ingredients has been used more as inorganic fillers in the non-asbestos friction members. Accordingly, as for a property of the friction member, a hardness tends to be increased and a porosity tends to be decreased. Then, as for a friction characteristic, an initial friction coefficient tends to be lowered since it depends on the hardness, while a high speed effectiveness and a fade characteristic also tend to be lowered since they depend on the porosity. In addition, noise tends to be generated.

Further, in vehicle disc brakes, it has generally been demanded for decreasing a size of a brake including a system so as to reduce an unsprung weight, in order to improve a fuel cost and a handling characteristic. For decreasing the size of the brake, it is necessary to improve a potency level of the brake (effective level of friction member). However, if the potency level of the brake (effective level of the friction member) is increased, a grindability would be increased so that squeal and judder characteristics tend to be degraded. Therefore, it is difficult to obtain both a high effective level and a commercial value with excellent squeal and judder characteristics, at the same time. As a countermeasure, while incorporation of a rubber type ingredient can provide an improved effect, the incorporation lowers a heat resistance of the friction material, which leads to deterioration of the effectiveness and an anti-fading property at a high speed condition and/or a high temperature condition.

In order to improve the foregoing drawback and provide a friction member with an excellent squeal characteristic, JP-A-05-331452 and JP-A-07-292348 disclose non-asbestos friction members of a dual-layered structure, in which at least one of friction material components is different or a contact ratio of the friction material components is different from each other in the layers parallel with the friction surface, and a rubber powder is added on a side in contact with a back plate (pressure plate). However, since the rubber is added solely in each of JP-A-05-331452 and JP-A-07-292348, an additive amount and a grain size of the rubber are restricted in view of the strength.

That is, as a result of increase in the ratio of using inorganic fillers along with the trend of using non-asbestos friction materials for vehicles, it becomes difficult to obtain friction members having desired characteristics such as the friction performance. While non-asbestos friction members are often used both in disc brakes and drum brakes, the brakes using the non-asbestos friction members may generate uncomfortable sounds so-called squeal during braking operation.

It is considered that the squeal is generated mainly by frictional vibrations between the friction member and the disc rotor or the drum during braking operation. For preventing the squeal, while it has been devised a composite friction member in which those of a composition of a preferred vibration characteristic are disposed to a portion of the friction member, or a friction member having a hardness distribution causing less frictional vibrations by devising the hardness distribution in the surface of the friction member. However, they involve a problem that the production cost is high, etc.

### SUMMARY OF THE INVENTION

One or more embodiments of the present invention provide a non-asbestos friction member having favorable characteristics against squeal and uncomfortable sounds, without deteriorating a performance of the friction member such as a frictional wear performance and without increasing a manufacturing cost.

In accordance with one or more embodiments of the present invention, a non-asbestos friction member is provided with: a friction material including a thermosetting resin binder, a reinforcing fiber, and a friction modifier; and a pressure plate, wherein the friction material is formed integrally with a pressure plate. The friction material includes a first layer friction material on a side of a friction surface and a second layer friction material on a side of the pressure plate. A pre-mix including at least an elastomer and a cross-linker is blended in the second layer friction material.

Further, the pre-mix may include fibers.

Further, the pre-mix may include from 10 to 97 vol % of the elastomer.

Further, the second layer friction material may include from 2 to 60 vol % of the pre-mix.

Further, “pre-mix” means those in which ingredients containing at least an elastomer, fibers, and a cross-linker are previously mixed into a state handled like a single material.

Since the second layer friction material containing the pre-mix is used on the side of the friction material in contact with the pressure plate, the flexibility of the friction material can be increased without changing the characteristic of the friction material and a non-asbestos friction member having favorable characteristics for squeal and uncomfortable sounds can be obtained. While the additive amount and the grain size of the rubber are restricted when it is used alone, the degree of freedom for the additive amount and the grain size is enhanced by formulating it into the pre-mix.

Other aspects and advantages of the invention will be apparent from the following description and the appended claims.

### BRIEF DESCRIPTION OF THE DRAWINGS

FIG. 1 is a schematic view showing the layer constitution (cross section) of a friction member (brake pad).

### DETAILED DESCRIPTION OF THE EXEMPLARY EMBODIMENTS

Exemplary embodiments of the invention will be described with reference to the accompanying drawings.

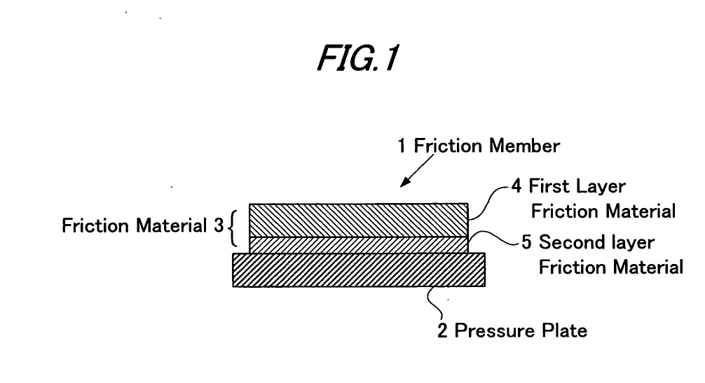

FIG. 1 is a side elevational view showing an example of a non-asbestos friction member according to an exemplary embodiments of the invention. Description is to be made to an example in a case of applying a non-asbestos friction member 1 in which a friction material 3 is formed on a pressure plate 2. The friction material 3 has a first layer friction material 4 formed on a side of a friction surface and a second layer friction material 5 formed on a side of a pressure plate 2.

Generally, the friction material for use in the brake is manufactured by way of each of the steps of blending and stirring raw materials for the friction material, preforming at a normal temperature, thermoforming, heat treatment and finishing such as polishing.

At first, a friction pad of a disc brake is shown as an example of a non-asbestos friction member 1 and each of the steps is to be described. FIG. 1 is a cross sectional view of the friction member 1 in which the friction material 3 integrated by thermoforming to a pressure plate 2 by way of an adhesive (not illustrated). Processing of the pressure plate mainly includes steps of sheet metal pressing, degreasing treatment, and pressure plate pre-heating. In the sheet metal pressing step, a previously selected pressure plate material is formed into a pressure plate of a predetermined shape by pressing or the like. In the degreasing step, oils and the fats deposited to the pressure plate during pressing are removed by using a detergent.

Preforming of the friction material 3 mainly includes steps of, measuring, blending, stirring, and preforming of raw materials. Each of the steps can be conducted in accordance with the existent friction material production technique. For example, a starting material is prepared by blending reinforcing fibers such as heat resistant organic fibers, inorganic fibers, or metal fibers, powdery materials such as an inorganic filler, a friction modifier, a solid lubricant, and a thermosetting resin binder each at a predetermined ratio and homogenizing the same sufficiently by mixing and stirring.

Then, the starting material is charged in a molding die, and preformed at a normal temperature under a pressure of a surface pressure of about from 10 to 100 MPa, to prepared a preliminarily molded product. The pressure plate and the preformed product of the friction material processed as described above are transferred to a thermoforming step. In the thermoforming step, the preliminarily heated pressure plate is at first set in a press, a preliminarily molded product is placed thereon and then they are put to thermoforming.

In the thermoforming step, the binder is hardened by a thermal reaction, so that en entire friction material is firmly bonded and integrated, in order to provide a strength and a hardness. Therefore, a performance of the friction material is determined by the adequacy of the thermoforming step. Further, the heating (after cure) condition also gives an effect on a quality of the friction material. The binder generally used for the friction material is a novolac type phenol resin (including various kinds of modified types), and hexamethylene tetramine or the like is added and mixed as a hardener. Further, resole type phenol resins are also used.

Since the friction materials used for vehicle disc brake pads, drum brake shoes, etc. convert the kinetic energy into the heat energy, they always generate heat to elevate temperature. Accordingly, for the friction material, not only a thermal resistance and a wear resistance are required, but a stable friction characteristic with less change of friction coefficient even under temperature change is also required. Further, it is also necessary that noises (squeal) and, accordingly, judder are not generated and versatile properties are required for the friction materials.

The raw materials for the friction material used in the embodiments of the invention is fibrous ingredients as the substrate, binders, friction modifiers, etc. used usually, which are non-asbestos type raw materials.

The friction material is bonded integrally to a pressure plate and used for disc brake pads, etc. The bonding has been generally conducted so far by adhesion, for which, a thermosetting resin adhesive such as a phenolic resin or an epoxy resin, or a crosslinkable rubber adhesive is used. Adhesion is generally conducted simultaneously with the molding of the friction material by molding under pressure and heating a powdery friction material or a preformed friction material together with a pressure plate.

Fibrous ingredients as the substrate for the friction material includes metal fibers such as steel fiber, copper fibers and glass fibers, organic fibers such as aromatic polyamide fibers (aramid pulp, etc.; commercial products manufactured by DuPont Co. under trade name of KEVLAR, etc.), acryl fibers, cellulose fibers, and flame-resistant acrylic fibers, and non-asbestos type inorganic fibers such as potassium titanate fibers, glass fibers, alumina fibers, carbon fibers, and rock wools. They may be used alone or two or more of them may be used in combination.

The binder includes, for example, thermosetting resins such as phenol resins, urea resins, melamine resins or modified resins thereof.

The friction modifier includes, for example, organic dusts such as cashew dusts, rubber dusts and melamine dusts; fillers such as calcium carbonate, barium sulfate, calcium hydroxide and mica; abrasives, for example, metal oxides such as magnesia, alumina, and zirconia; metal powders such as aluminum powder, copper powder, and zinc powder, and lubricants such as graphite and molybdenum sulfide. One or two or more of them in proper combination selected from them can be sued as the filler.

The constituent material for the pre-mix used in the embodiments of the invention is an elastomer and a cross-linker and, further, may contain fibers, for which general ingredients used for the friction materials can be used respectively.

As the pre-mix, those comprising silicone rubber, butyl rubber, chlorobutyl rubber, NBR rubber, or olefin, vinyl chloride, styrene or polyester type elastomers as the base and fibers such as steel fibers, aramid fibers, cellulose fibers, and acryl fibers, graphite, sulfur, and cross-linker and prepared by using a stirring machine such as a kneader or a banbury mixer are used. In a case of using the aramid fibers, those having an average diameter of from 1 to 50 μm and an average length of about 0.5 to 5 mm are suitable. As the crosslinker, those substances providing a crosslinking structure for the elastomer by reaction are used and a vulcanization accelerator is used in a case of the rubber. As the vulcanization accelerator, those compounds such as thiazole type MBK, MBTS, ZmMBT, thiuram type TMTM, TMTD, TETD (each by abbreviation) can be used. The elastomer, for example, rubber as a base is used by the content of from 10 to 97 vol %, preferably, 20 to 50 mol % based on the entire portion. The content of the fibers is from 1 to 90 vol %, preferably, from 3 to 70 vol % based on the entire portion. The content of the vulcanization accelerator is from 0.1 to 10 vol %, preferably, from 0.5 to 5 vol % based on the entire portion. The average grain size of the pre-mix in the embodiments of the invention is within a range from 0.1 to 8 mm, preferably, from 0.5 to 4 mm.

The friction material of the embodiments of the invention contains a thermosetting resin binder, reinforcing fibers, and a friction modifier and includes a first layer friction material on the side of a friction surface and a second layer of the friction material on the side of the pressure plate. The second layer friction material comprises at least the binder, the filler, fibers, and the pre-mix. For example, compounds such as phenol resin, calcium carbonate, barium sulfate, vermiculite, and xonotlite (calcium hydrate) are used preferably. Further, for the second layer friction material, pre-mix (composite material of elastomer, fiber, graphite, etc.) is used by from 2 to 60 vol % and, preferably, from 10 to 40 vol %. The thickness of the second layer friction material is preferably within a range from 1 to 6 mm.

Further, the blending ingredient of the low steel friction material in the friction material of the embodiments of the invention comprises phenol resin, steel fibers, aramid fibers, cellulose fibers, calcium carbonate, barium sulfate, mica, metal powder, sulfide, graphite, organic dust, alumina, magnesia, minerals, and iron oxides.

In the embodiments of the invention, as the friction modifier described above, molybdenum disulfide particles, carbon particles, as well as in organic powder of silica, alumina, talc etc., are preferably used in combination. For the friction modifier particles, it is preferred that the average grain size is from 5 to 20 μm for molybdenum disulfide, the average grain size is from 0.1 to 10 μm for the alumina particles, and the average grain size is from 10 to 50 μm for the carbon particles.

While the outline for the manufacturing step of the non-asbestos friction member according to the exemplary embodiment of the invention has already been described, in which a pressure plate formed into a predetermined shape by a sheet metal pressing, applied with a degreasing treatment and a primer treatment and then coated with an adhesive in the same manner as in the existent method, and a sufficiently blended raw materials including reinforcing fibers such as heat resistant organic fibers, or metal fibers, an organic or inorganic filler, a friction modifier and a thermosetting resin binder, or a preformed product prepared by blending the above raw materials and molding them at a normal temperature under a predetermined pressure (preforming) are thermoformed in a thermoforming die at predetermined temperature and pressure in the thermoforming step to integrally secure both of the members, applying after cure and finally applying a finishing treatment.

### EXAMPLE

The present invention is to be described specifically by way of examples but the scope of the invention is not restricted to the examples.

### Examples 1 to 6

Table 1 shows blend formulations for 9 types of pre-mixes used for the second layer friction material in the friction material of the invention. Specifically, chlorobutyl rubber, silicone rubber, NBR rubber, steel fibers, aramid fibers, cellulose fibers, calcium carbonate, barium sulfate, and a vulcanization accelerator (MBTS), while changing the ratio variously were stirred under heating by a kneader and pelletted into an amorphous shape particles of about 1 to 3 mm.

TABLE 1
Blend examples of pre-mix (vol %)

| | #1 | #2 | #3 | #4 | #5 | #6 | #7 | #8 | #9 |
|---|---|---|---|---|---|---|---|---|---|
| Chlorobutyl rubber | 10.0 | 20.0 | 30.0 | | | 40.0 | 60.0 | 30.0 | 97.0 |
| Silicone rubber | | | | 30.0 | | | | | |
| NBR rubber | | | | | 30.0 | | | | |
| Steel fiber | 29.5 | 19.0 | 19.0 | 19.0 | 19.0 | 18.5 | 18.0 | | |
| Aramid fiber | 30.0 | 30.0 | 25.0 | 25.0 | 25.0 | 20.0 | 10.0 | | |
| Cellulose fiber | 30.0 | 30.0 | 25.0 | 25.0 | 25.0 | 20.0 | 10.0 | | |
| Calcium carbonate | | | | | | | | 34.0 | |
| Barium sulfate | | | | | | | | 34.0 | |
| Vulcanization accelerator | 0.5 | 1.0 | 1.0 | 1.0 | 1.0 | 1.5 | 2.0 | 1.0 | 3.0 |
| (MBTS) | | | | | | | | | |

Table 2 shows the blend preparations of the friction material of the invention and the result of a test for the friction material. The friction material was a non-asbestos friction material comprising a binder (phenol resin), a filler (calcium carbonate, barium sulfate, etc.), a lubricant (graphite, etc.), an abrasive (metal oxide, etc.), organic fibers (aramid fibers, etc.), metal fibers (steel fibers, etc.), and metals. On the other hand, for the blending ingredient for the second layer friction material, a binder (phenol resin), a filler (calcium carbonate), barium sulfate, etc., aramid fibers, and a pre-mix were blended at the ratio of numerical values described in Table 2. As the pre-mix, Blending Example 3 in Table 1 was used for Examples 1 to 5 and blending Example 9 was used for Example 6.

TABLE 2
Blend Example (premix #3 used) (vol %)

| | | | | | | | | | Comparative | |
|---|---|---|---|---|---|---|---|---|---|---|
| | | | Example | | | | | | Example | |
| Blend | | | 1 | 2 | 3 | 4 | 5 | 6 | 1 | 2 |
| First layer of | Low steel friction material* | | 100 | 100 | 100 | 100 | 100 | 100 | 100 | 80 |
| friction | Pre-mix | | — | — | — | — | — | — | — | 20 |
| material | | | | | | | | | | |
| Second layer | Phenol resin | | 20 | 20 | 20 | 20 | 20 | 20 | 20 | 20 |
| friction | Filler (calcium carbonate) | | 25 | 20 | 15 | 10 | 5 | 15 | 30 | 30 |
| material | Filler (barium sulfate) | | 25 | 20 | 15 | 10 | 5 | 15 | 30 | 30 |
| | Aramid fiber | | 20 | 20 | 20 | 20 | 20 | 20 | 20 | 20 |
| | Premix | | 10 | 20 | 30 | 40 | 50 | 30(#9) | 0 | 0 |
| Comparison | μ | | 0.42 | 0.42 | 0.42 | 0.42 | 0.42 | 0.42 | 0.42 | 0.40 |
| for friction | Fade (min μ) | | 0.28 | 0.3 | 0.3 | 0.3 | 0.3 | 0.3 | 0.28 | 0.22 |
| performance | Noise | Squeaking | A | A | A | A | A | A | B | A |
| | | uncomfortable | B | B | A | A | A | A | C | A |
| | | sound | | | | | | | | |

| | | | | | | | | | |
|---|---|---|---|---|---|---|---|---|---|
| Physical | Sharing strength kN** | 35 | 33 | 30 | 26 | 23 | 23 | 35 | 38 |
| property | Compressive deformation | 150 | 155 | 160 | 165 | 170 | 175 | 150 | 165 |
| | (μm)*** | | | | | | | | |

*Low steel friction material (vol %)

| | |
|---|---|
| Phenol resin: | 20 |
| Calcium carbonate | 10 |
| Barium sulfate | 10 |
| Cashew dust | 5 |
| Graphite | 20 |
| alumina | 5 |
| amide fiber | 5 |
| steel fiber | 20 |
| cupper | 5 |

**Shearing strength aimed at about 19.6 kN or more
***Compressive deformation (AK-standard: Displacement amount corresponding to liquid pressure: 160 bar)
A: good
B: just satisfying the aim
C: poor

(Preparation of Brake Pad)

After charging a mixture of the second layer friction material prepared in accordance with the formulation described in Table 2 to a lower portion of a molding die, a mixture of a first layer friction material was charged thereover, preforming them, then applying a heat treatment to prepare a brake pad. Thermoforming was conducted under the condition of the heat treatment at a temperature from 100 to 170° C., under a pressure of 20 to 80 MPa, for time of from 1 to 10 min. Then, a heat treatment was applied at a temperature of from 200 to 400° C., and for a time of from 20 to 200 min. The thickness of the first layer friction material was 10 min and the thickness of the second layer friction material was 2 mm in the friction material.

Friction performance and the physical property value of the thus prepared 9 types of brake pads are also shown in Table 2. The friction performance and the physical property value were measured in accordance with the European Standard: AK-Standard (displacement amount corresponding to liquid pressure: 160 bar). From the result of Table 2, the content of the pre-mix in the second layer friction material is appropriately from 30 to 40 vol % in view of the balance for the sharing strength, the compressive deformation, and the friction characteristic. For the compressive deformation, it is about from 120 to 180 μm while also depending on the effect of caliper rigidity, etc.

### Comparative Example 1

A case where pre-mix is not contained in the second layer, while effectiveness was good, noise was not good.

### Comparative Example 2

A case where pre-mix ingredient is contained by 20% in the first layer, while noise was good, the anti-fading property is lowered due to the effect of the rubber contained in the pre-mix.

As described in the above, a friction member according to the embodiments of the present invention is useful for brake pads, clutch plates, brake shoes etc. for automobiles, railways, and industrial machines.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

What is claimed is:

1. A non-asbestos friction member comprising:
a friction material including a thermosetting resin binder, a reinforcing fiber, and a friction modifier; and
a pressure plate, wherein the friction material is formed integrally with the pressure plate,
wherein the friction material comprises a first layer friction material on a side of a friction surface and a second layer friction material on a side of the pressure plate, and
a pre-mix including at least an elastomer and a cross-linker are blended in the second layer friction material.

2. The non-asbestos friction member according to claim 1, wherein the pre-mix includes fibers.

3. The non-asbestos friction member according to claim 1, wherein the pre-mix includes from 10 to 97 vol % of the elastomer.

4. The non-asbestos friction material to claim 1, wherein the second layer friction material includes from 2 to 60 vol % of the pre-mix.
